(19) United States
(12) Patent Application Publication
(10) Pub. No.: US 2017/0005891 A1
(43) Pub. Date: Jan. 5, 2017

(54) INTELLIGENT ROUTING IN INFORMATION CENTRIC NETWORKING

(71) Applicant: FUJITSU LIMITED, Kawasaki-shi (JP)

(72) Inventors: Lei LIU, Sunnyvale, CA (US); Akira ITO, San Jose, CA (US); Zilong YE, Sunnyvale, CA (US)

(21) Appl. No.: 14/845,151

(22) Filed: Sep. 3, 2015

Related U.S. Application Data
(60) Provisional application No. 62/187,158, filed on Jun. 30, 2015.

(51) Int. Cl. H04L 12/26; H04L 12/751; H04L 29/08; H04L 29/06

(52) U.S. Cl. CPC H04L 43/0811; H04L 69/22; H04L 45/02; H04L 67/10

(57) ABSTRACT

The present disclosure includes a method of intelligent routing in an information centric networking network, the method including receiving a first notification that a connection between a content host and a first network device has changed. The method may further include receiving a pending interest packet from the first network device, the pending interest packet requesting content stored on the content host, the content to be routed to a second network device, and receiving a second notification that a connection between the content host and a third network device has changed. The method may additionally include determining a new path to the second network device for the content requested by the pending interest packet that includes the third network device, and sending a message to instruct that a content packet containing the content responsive to the pending interest packet be routed to the second network device along the new path.

### FIELD

The embodiments discussed herein are related to intelligent routing in information centric networking (ICN).

### BACKGROUND

The Internet is currently based on an Internet Protocol (IP) structure, with a frame of reference of where content is located, for example, at a given IP address. In information centric networking (ICN) networks, the frame of reference is based on what content is requested, rather than where the content is located.

The subject matter claimed herein is not limited to embodiments that solve any disadvantages or that operate only in environments such as those described above. Rather, this background is only provided to illustrate one example technology area where some embodiments described herein may be practiced.

### SUMMARY

Some embodiments of the present disclosure may include a method of intelligent routing in an information centric networking (ICN) network. The method may include receiving a first notification that a connection between a content host and a first network device has changed. The method may further include receiving a pending interest packet from the first network device, the pending interest packet requesting content stored on the content host, the content to be routed to a second network device. The method may also include receiving a second notification that a connection between the content host and a third network device has changed. The method may additionally include determining a new path to the second network device for the content requested by the pending interest packet that includes the third network device. The method may further include sending a message to instruct that a content packet containing the content responsive to the pending interest packet be routed to the second network device along the new path.

The object and advantages of the embodiments will be realized and achieved at least by the elements, features, and combinations particularly pointed out in the claims. Both the foregoing general description and the following detailed description are exemplary and explanatory and are not restrictive.

### BRIEF DESCRIPTION OF THE DRAWINGS

Example embodiments will be described and explained with additional specificity and detail through the use of the accompanying drawings in which:

FIG. 1 is a diagram representing an example information centric networking (ICN) network related to intelligently routing packets, according to some embodiments of the present disclosure;

FIG. 2 illustrates an example computing system configured to operate within an ICN network, according to some embodiments of the present disclosure;

FIG. 3 is an example diagram of various tables within a network device, according to some embodiments of the present disclosure;

FIG. 4 is a flowchart of an example method of intelligent routing in an ICN network, according to some embodiments of the present disclosure;

FIG. 5A is a flowchart of another example method of intelligent routing in an ICN network, according to some embodiments of the present disclosure;

FIG. 5B is a flowchart of another example method of intelligent routing in an ICN network, according to some embodiments of the present disclosure;

FIG. 5C is a flowchart of another example method of intelligent routing in an ICN network, according to some embodiments of the present disclosure; and

FIG. 5D is also a flowchart of another example method of intelligent routing in an ICN network, according to some embodiments of the present disclosure.

### DESCRIPTION OF EMBODIMENTS

The present disclosure relates to the intelligent routing of interest packets and content packets in an information centric networking (ICN) network. An example ICN network may include a content host that may receive interest packets requesting content and may respond with the requested content in a content packet. A location coordinator may be introduced that may be aware of the topology of the ICN network such that if a content host changes network connections, the location coordinator may facilitate the intelligent routing of interest packets and/or content packets, which were routed to the content host through a prior connection, through the changed connections within the ICN network.

In the present disclosure, a packet requesting content may be referred to as an interest packet, and a packet providing content requested by an interest packet may be referred to as a content packet.

Embodiments of the present disclosure are explained with reference to the accompanying drawings.

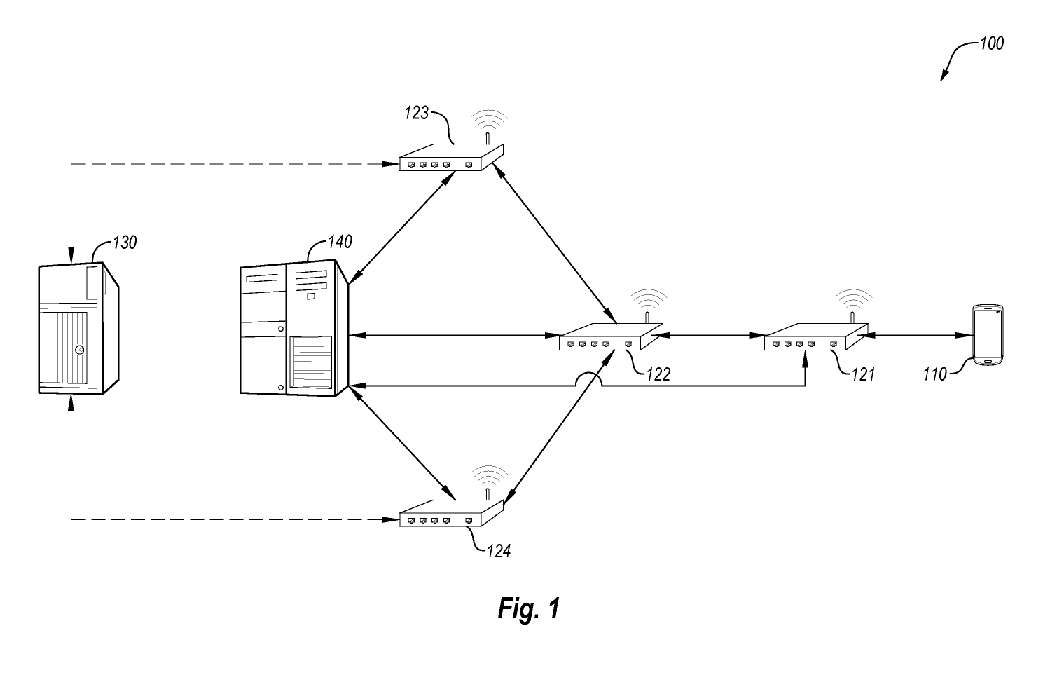

FIG. 1 is a diagram representing an example network 100 operating as an ICN network, according to some embodiments described in this disclosure. The network 100 may include an end user 110, one or more network devices 121, 122, 123, and 124, a content host 130, and a location coordinator 140. While the network 100 may have packets, such as interest packets and content packets, routed through the network 100 according to default rules, in some embodiments the location coordinator 140 may facilitate the intelligent routing of packets within the network 100 in a manner that deviates from the default rules.

As illustrated in FIG. 1, the double arrow lines may indicate a connection over which data may be communicated, including general traffic (e.g. interest packets and content packets) for the network 100 as well as management traffic (e.g. connection status notifications). The dashed lines may indicate a connection which may or may not be formed, or may be formed at one point in time and later weakened, strengthened, or broken, or may not be formed at one point in time and later formed.

The end user 110 may include any device, system, component, or collection of components configured to request content from a remote device. The end user 110 may be implemented as a computer (such as a desktop, laptop, server, etc.), as a mobile device (such as a cellular telephone, personal digital assistant (PDA), tablet, etc.), or as any other device connected to a network (such as a network-enabled thermostat, refrigerator, or other appliance). The end user 110 may include a processor, a memory, and a storage media. By way of example, during operation in the network 100, the end user 110 may send an interest packet to the network device 121. Because the network 100 is operating as an ICN network, the interest packet may not indicate where the desired content is located, but instead may name the content desired by the end user 110.

The network devices 121, 122, 123, and 124 may include any device, system, component, or collection of components configured to receive, handle, and/or process packets within the network 100. The network devices 121, 122, 123, and 124 may each be implemented as a router, a gateway, a switch, or any other network element. In some embodiments, the network devices 121, 122, 123, and 124 may each include a processor, a memory, and a storage media. The network devices 121, 122, 123, and 124 may each also include one or more interfaces over which the network devices 121, 122, 123, and 124 communicate. An interface may include a physical and/or logical entrance or exit point for communication with a network device. For example, the network device 121 may have a first interface connecting to the end user 110 and a second interface connecting to the network device 122.

In some embodiments, the network devices 121, 122, 123, and 124 may each include a content store, a pending interest table (PIT), and a forwarding information base (FIB). The content store, PIT, and FIB may be physical or logical storage components or locations within the memory and/or the storage media of the network devices 121, 122, 123, and 124. An example of an operation/structure/information in a content store, a PIT, and a FIB are now explained with respect to the network device 121, but may apply to the network devices 122, 123, and 124. In these and other embodiments, a content store may operate as a storage location for the network device 121 to store content which has been requested by another device in the network 100. By using the content store, content that is frequently requested may be located in the content stores of multiple network devices and may be provided to a device requesting the content more quickly and/or efficiently.

In some embodiments, the PIT may serve as a status indicator of what interest packets have been received by the network device for which the network device is still awaiting a content packet. For example, the PIT may have table entries associating requested content with interfaces of the network device that have received interest packets requesting the content. The PIT may be used when a content packet is received by the network device to identify if that content has been requested and which interfaces have requested that content so the content packet may be sent out from the network device on the requesting interfaces.

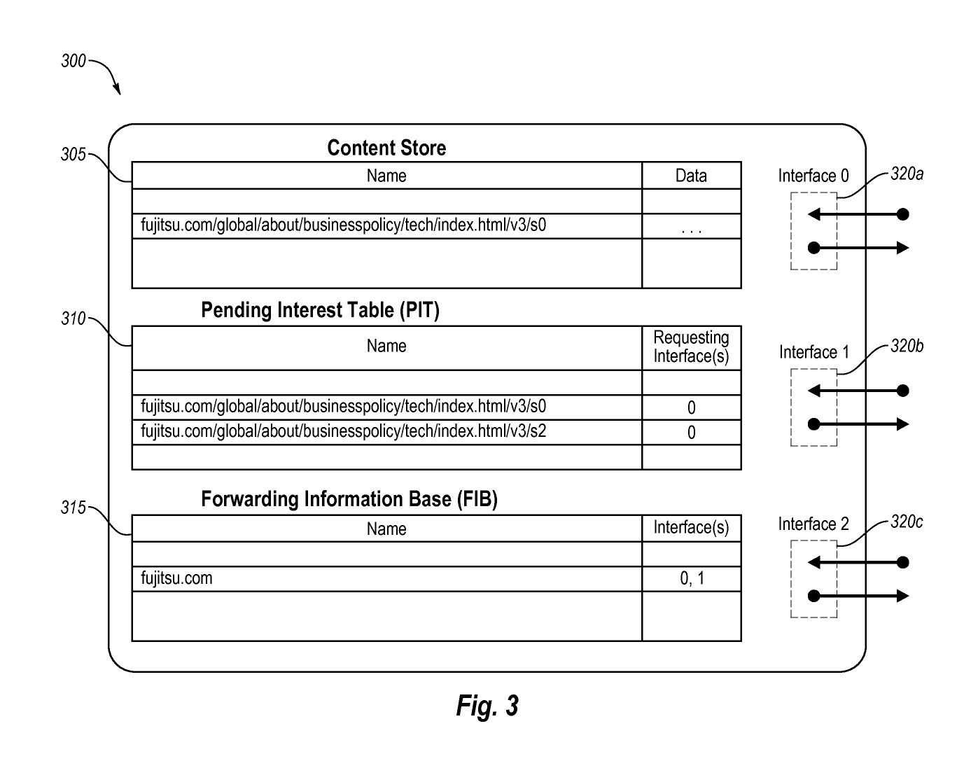

In some embodiments, the FIB may be a database, set of rules, protocols, or the like by which the network device may determine where to forward an interest packet when received by the network device. For example, when an interest packet is received at the network device, the FIB may be utilized to determine which interface or interfaces of the network devices are used to transmit the interest packet to request the content. An example of a content store, a PIT, and a FIB may also be illustrated in FIG. 3.

By way of example, the operation of the network device 121 is now described when operating under default rules. The network devices 122, 123, and 124 may operate according to the same principles as described with respect to the network device 121.

For example, when the network device 121 receives an interest packet (for example, from the end user 110 or another network device 122), the network device 121 may check if the interest packet is requesting content already stored in the content store of the network device 121. If the content is in the content store of the network device 121, the network device 121 may send the content in a content packet back over an interface through which the interest packet was received. For example, as shown in FIG. 1, the interest packet may be sent from the end user 110 and received by the network device 121 at an interface and the content packet may be sent back out over that interface connecting the end user 110 to the network device 121. If the content is not in the content store of the network device 121, the network device 121 may check the PIT of the network device 121 to determine if there is an existing entry for the name of the content which has been previously requested by other interest packets. If there is no entry, the network device 121 may create an entry for the interest packet in the PIT. The entry for the PIT may include the name of the content requested and the interface over which the interest packet was received. If there is an entry in the PIT for the interest packet, the network device 121 may update the entry for the interest packet to also include the interface over which the interest packet was received. For a new entry in the PIT, the network device 121 may forward the interest packet according to the rules in the FIB. For example, the rules in the FIB may follow a Named Data Link State Routing (NLSR) protocol or other routing protocols used in ICN networks. Forwarding the interest packet may cause the interest packet to be forwarded to one interface or multiple interfaces. Using ICN default rules, a single interest packet may be sent for content, and any additional interest packets requesting the same content may simply update the PIT entry. Also, one interest packet on an interface may result in one content packet being sent over the same interface.

As another example, when the network device 121 receives a content packet, the network device 121 may check the PIT to determine whether it has an entry for the name of the content in the content packet. If there is no entry for the content, the network device 121 may discard the content packet. If there is an entry in the PIT for the name of the content in the content packet, the network device 121 may store the content of the content packet in the content store and may then transmit the content packet out to each of the interfaces in the PIT entry associated with the name of the content in the content packet. As described above, interest packets may have been received on multiple interfaces requesting the content. After the content packets have been sent, the network device 121 may remove the entry in the PIT for the content.

The content host 130 may include any device, system, component, or collection of components configured to store and provide content within the network 100. The content host 130 may include a processor, a memory, and a storage media. In some embodiments, the content host 130 may change physical locations such that a connection or a strength of a connection between the content host 130 and one or more of the network devices 121, 122, 123, and 124 may vary. For example, the content host 130 may be initially connected to the network device 123. The content host 130 may change locations such that the connection to the network device 123 is weakened or broken and a connection to the network device 124 may be formed or strengthened. When the content host 130 receives an interest packet for the content stored on the content host 130, the content host 130 may send a content packet with the content to the device that sent the interest packet.

The following is an example of operation of the default rules when the content host changes connections. If the end user 110 requested content stored on the content host 130 in the network 100 (and for the sake of the example, not stored on any of the intervening network devices such that the requested content comes from the content host 130), the network device 121 may update the PIT of the network device 121 with the interest packet and may send the interest packet to the network device 122 based on the FIB of the network device 121. The network device 122 may update the PIT of the network device 122 with the interest packet and may send the interest packet to the network device 123 based on the FIB of the network device 122. The network device 123 may update the PIT of the network device 123 with the interest packet and may send the interest packet to the content host 130.

The content host 130 may select the requested content and form a content packet to send the requested content based on the interest packet. The content host 130 may send the content packet to the network device 123. The network device 123 may store the content of the content packet in the content store of the network device 123, remove the PIT entry, and may send the content packet to the network device 122 according to the PIT entry. The network device 122 may store the content of the content packet in the content store of the network device 122, remove the PIT entry and may send the content packet to the network device 121 according to the PIT entry. The network device 121 may store the content of the content packet in the content store of the network device 121, remove the PIT entry and may send the content packet to the end user 110 according to the PIT entry. The above-description may describe the operation of the network devices 121, 122, 123, and 124 according to the default rules, generally.

In some embodiments, the content host 130 may have one or more connections made or broken that may affect the handling of interest packets. For example, the content host 130 may be initially connected to the network device 123 and there may be one or more interest packets being routed through the network 100 to the network device 123 to request content from the content host 130. The content host 130 may change locations such that the connection to the network device 123 may be broken and a connection to the network device 124 may be formed. In such a circumstance, the network device 123 may receive a hand-off notification from the content host 130 and the network device 123 may begin caching, buffering, or otherwise storing any interest packets received that are requesting content from the content host 130. After the content host 130 is connected to the network device 124, a virtual interest packet may be sent from the network device 124 to the network device 123 to retrieve any pending interest packets stored at the network device 123.

After receiving the virtual interest packet requesting the stored interest packets, the network device 123 may send the stored interest packets back to the requesting interface. For example, the network device 123 may send the stored interest packets to the network device 122, the network device 122 may then update the PIT of the network device 122 to include the interface connected to the network device 123 because that is where the network device 122 received the interest packet. The network device 122 may send the stored interest packets to the network device 124. The network device 124 may update the PIT of the network device 124 to include the interface connected to the network device 122. The network device 124 may send the stored interest packets to the content host 130.

The content host 130 may send content packets responsive to the stored interest packets through the requesting interface, e.g. to the network device 124. The network device 124 may store the content in the content store of the network device 124, may remove the PIT entry, and may send the content in a content packet to the network device 122. The network device 122 may have PIT entries for the content to be sent to both the network device 121 (because of the initial user 110 request) and the network device 123 (because of the stored interest packets). The network device 122 may store the content in the content store of the network device 122, may send the content in content packets to both of the network devices 123 and 121, and may remove the entry from the PIT.

The network device 121 may store the content in the content store of the network device 121, may remove the PIT entry, and may send the content in a content packet to the end user 110. The network device 123 may have entries in the PIT for the content to be sent to the network device 122 (because of the initial user request). The network device 123 may store the content in the content store of the network device 123, may remove the PIT entry, and may send the content in a content packet to the network device 122. The network device 122 may discard the content packet as the network device 122 no longer has a PIT entry for the content.

Operating in such a circumstance may result in unnecessary and/or wasteful network traffic in the network 100. For example, routing the content packet from the network device 122 to the network device 123 and then back to the network device 122 where it is discarded may be unnecessary and/or wasteful.

In some embodiments, interest packet and/or content packets may be handled in a way to reduce or minimize unnecessary network traffic in an ICN network. For example, the introduction of a location coordinator into an ICN network that is configured to maintain the network topology and may provide messages to network devices regarding new routes for packets may provide a mechanism to reduce or minimize unnecessary network traffic in an ICN network.

The location coordinator 140 may include any device, system, component, or combination thereof configured to monitor the topology of the network 100 and assist in the intelligent routing of packets within the network 100. The location coordinator 140 may be implemented as a stand-alone computer system, or may be a smaller component of an existing computer system such as a network management system (NMS), NDNS (domain name services (DNS) for Named Data Networking (NDN)), or software-defined networking (SDN) controller. The location coordinator 140 may include a processor, a memory, and a storage media. The location coordinator 140 may be in communication with one or more of the network devices 121, 122, 123, and 124. In some embodiments, the location coordinator 140 may monitor and maintain the current topology and status of the network 100. For example and with reference to FIG. 1, the location coordinator 140 may maintain the information that the network device 121 is connected to the network device 122, that the network device 122 is connected to both the network device 123 and the network device 124, and that the content host 130 is connected to one or both of the network devices 123 and 124.

In some embodiments, the location coordinator 140 may receive notification that the content host 130 may be moving connections or may have already moved connections. Such a notification may be received when a network device is mobile or when the content host 130 is mobile. For example, as the content host 130 notifies the network device 123 that it is moving or that the connection between the content host 130 and the network device 123 has been otherwise weakened or broken, the network device 123 may in turn notify the location coordinator 140 of the change. In like manner, as the content host 130 notifies the network device 124 that the content host 130 has moved into connection with the network device 124 or that a connection between the content host 130 and the network device 124 has otherwise been strengthened or formed, the network device 124 may in turn notify the location coordinator 140 of this change. When such a transition or change has occurred, there may be pending interest packets at the network device 123 which may not be able to be fulfilled by the content host 130 because of the change in connection. These may be, for example, PIT entries that the network device 123 has put on hold or cached as the content host 130 moves from being connected to the network device 123 to being connected to the network device 124. In some embodiments, rather than the network devices 123 and 124 communicating the hand-off or other connection changes to the location coordinator 140, the content host 130 may communicate the hand-off or other connection changes information to the location coordinator 140.

In some embodiments, the location coordinator 140 may facilitate the intelligent routing of the pending interest packets. The location coordinator 140 may facilitate the intelligent routing in a number of methods, or a combination of different potential methods. In some embodiments, the location coordinator 140 may send a message or otherwise notify the network device 123 to send the pending interest packets (or the name of the pending interest packets) and the corresponding requesting network devices (e.g. network device 122 in the example illustrated in FIG. 1) for the pending interest packets to the location coordinator 140. The location coordinator 140 may determine a new path for content packets that are responsive to the pending interest packet. The new path for the responsive content packets may include a network device that would have been in the previous route of the interest packet when the location coordinator was connected to the network device 123. For example, as illustrated in FIG. 1, the location coordinator 140 may determine that the responsive content packets may be routed through the network device 124 to the network device 122. The topology illustrated in FIG. 1 is an example topology. In other topologies, any number of network devices may be included in the new path selected by the location coordinator 140.

In some embodiments, a new path may be determined by the location coordinator 140 based on a number of factors, including a number of hops between network devices, distance the responsive content packets may travel, network load, network device load, network device capability, bandwidth, latency, etc. After the new path has been determined, the location coordinator 140 may send a message or notification to the network devices in the new path to update the PIT entries of the network devices to include the pending interest packets that are to be fulfilled along the new path. For example, the location coordinator 140 may send a message to the network device 124 instructing the network device 124 to update the PIT of the network device 124 to include a new entry for the same content that was previously included in the PIT of the network device 123. The new entry in the PIT of the network device 124 may include the interface connecting to the network device 122. Using such a message, when the content host 130 provides a content packet with the requested content to the network device 124, the network device 124 has an entry for that content in the PIT of the network device 124 and may send the content packet on to the network device 122 based on that entry in the PIT. After reception by the network device 122, the content packet may be handled using default rules such that the network device 122 routes the content packet to the network device 121 which may route the content packet to the end user 110.

In some embodiments, the location coordinator 140 may communicate with the content host 130. For example, when informed of the pending interest packets at the network device 123, the location coordinator 140 may instruct the content host 130 to include an additional header on top of the content packet. The header may include a name of a target location in the network 100, or may include a series of stops in the network 100. For example, the header may include information indicating that the network device 122 is the target location. The FIB of each of the network devices may use the header to route the content packet with the header to the target network device. For example, the network device 124 may receive the content packet with the additional header designating the network device 122 and may route the content packet towards the network device 122 based on the FIB using the header. After the content packet arrives at the target network device, the header may be removed from the content packet and the content packet may be handled according to the default rules. For example, once the content packet arrives at the network device 122, the network device 122 may remove the header and may look up the name of the content in the PIT and route the content packet to the network device 121, which may in turn route the content packet to the end user 110. This type of header may be referred to as a tunnel or tunnel header used to create a path to the desired network device. Using the example of FIG. 1, such a header may create a tunnel from the network device 124 to the network device 122.

In some embodiments, the location coordinator 140 may communicate with other network devices once a new path has been determined. For example, the location coordinator 140 may send a message to the network device 122 instructing it to issue a new interest packet for the content to the network device 124. The network device 124 may pass the interest packet to the content host 130 and the content host 130 may pass the content packet back to the network device 124 and back down the path of pending interest packets according to the default rules. In some embodiments, using the new interest packet may leave buffered interest packets at the network device 123 which may be unresolved. However, a time-out or other feature may be included such that buffered interest packets that are not handled within a certain time may be automatically removed. Using such automatic removal, even if a pending interest packet at the network device 123 is unresolved, the pending interest packet may time out and be automatically removed.

Modifications, additions, or omissions may be made to FIG. 1 without departing from the scope of the present disclosure. For example, the network 100 may include more or fewer elements than those illustrated and described in the present disclosure. For example, the network 100 may include many more network devices, content hosts, and end users arranged in any topology. The relatively small number of network nodes and simple topology illustrated in FIG. 1 are for ease in understanding and are not limiting.

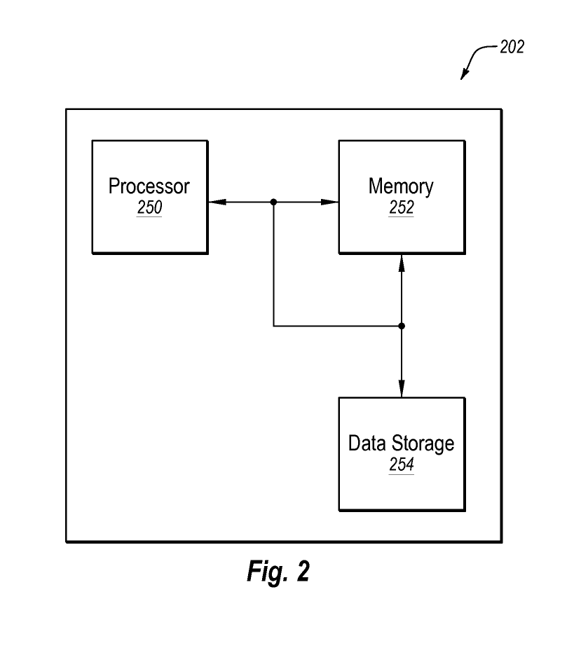

FIG. 2 illustrates a block diagram of an example computing system 202, according to some embodiments the present disclosure. Any one of the end user 110, the network devices 121, 122, 123, or 124, the content host 130, and/or the location coordinator 140 may be implemented as a computing system such as the example computing system 202. The computing system 202 may be configured to implement one or more operations of the present disclosure. The computing system 202 may include a processor 250, a memory 252, and a data storage 254. The processor 250, the memory 252, and the data storage 254 may be communicatively coupled.

In general, the processor 250 may include any suitable special-purpose or general-purpose computer, computing entity, or processing device including various computer hardware or software modules and may be configured to execute instructions stored on any applicable computer-readable storage media. For example, the processor 250 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 2, the processor 250 may include any number of processors configured to perform, individually or collectively, any number of operations described in the present disclosure.

In some embodiments, the processor 250 may interpret and/or execute program instructions and/or process data stored in the memory 252, the data storage 254, or the memory 252 and the data storage 254. In some embodiments, the processor 250 may fetch program instructions from the data storage 254 and load the program instructions in the memory 252. After the program instructions are loaded into memory 252, the processor 250 may execute the program instructions.

For example, in some embodiments, a location coordinator may be implemented as a stand-alone computer system, or may be a smaller component of an existing computer system such as a NMS, NDNS, or SDN controller. In these and other embodiments, the data storage 254 may include program instructions to implement operations performed by the location coordinator, such as the location coordinator 140 of FIG. 1. The processor 250 may fetch the program instructions from the data storage 254 and may load the program instructions in the memory 252. After the program instructions are loaded into memory 252, the processor 250 may execute the program instructions such that the computing system may implement the operations performed by the location coordinator as directed by the instructions.

The memory 252 and the data storage 254 may include computer-readable storage media for carrying or having computer-executable instructions or data structures stored thereon. Such computer-readable storage media may include any available media that may be accessed by a general-purpose or special-purpose computer, such as the processor 250. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 250 to perform a certain operation or group of operations.

Modifications, additions, or omissions may be made to the computing system 202 without departing from the scope of the present disclosure. For example, in some embodiments, the computing system 202 may include any number of other components that may not be explicitly illustrated or described.

FIG. 3 is an example diagram of various tables within a network device 300, according to some embodiments of the present disclosure. The network device 300 may include a content store 305, a PIT 310, a FIB 315, and interfaces 320a (Interface 0), 320b (Interface 1), and 320c (Interface 2). Each of these components may be implemented as described with respect to FIG. 1. For example, when an interest packet is received at the network device 300 at the interface 320a, the network device 300 may determine if the content requested in the interest packet is stored in the content store 305. If the content is in the content store 305, the network device 300 may send the content back through the interface 320a in a content packet. If the content is not stored there, the network device 300 may updated the PIT 310 to include the interest packet. Updating the PIT 310 may include generating a new entry in the PIT 310 if no entry exists for the content or adding the interface 320a to the PIT entry if there is an existing PIT entry for the requested content. When sending an interest packet, the network device 300 may forward the interest packet according to the FIB 315, which may operate (e.g. may be automatically updated) according to the NLSR protocol.

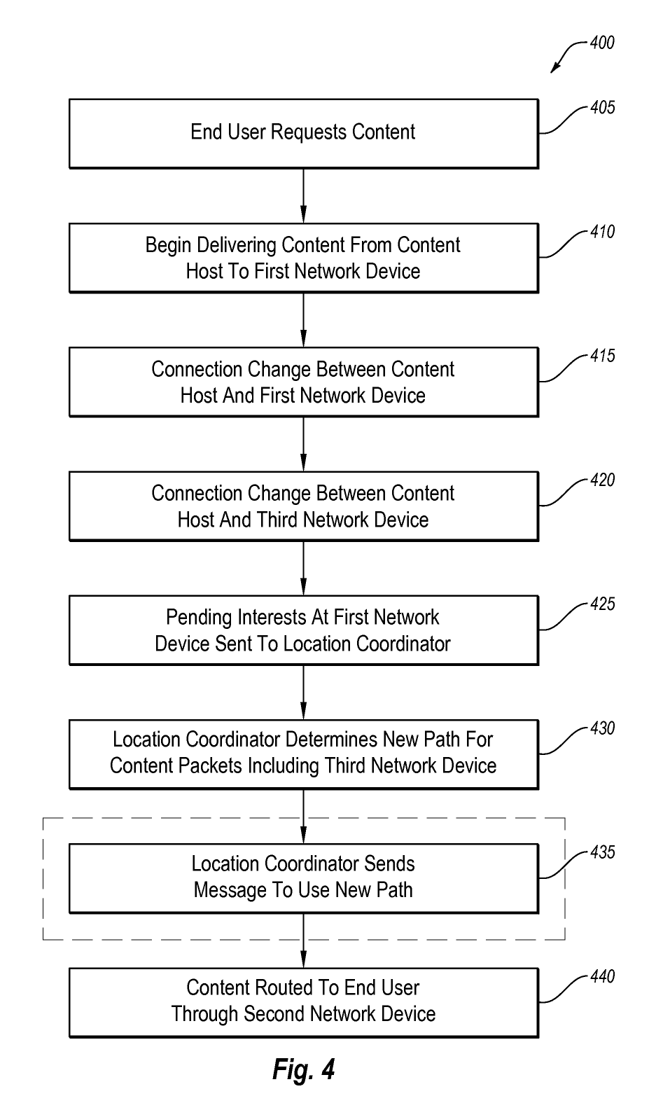

FIG. 4 is a flowchart of an example method 400 of intelligent routing in an ICN network, according to some embodiments of the present disclosure. The method 400 may be performed by any suitable system, apparatus, or device. For example, the network 100 of FIG. 1 or the computing system 202 of FIG. 2 may perform one or more of the operations associated with the method 400. In these and other embodiments, program instructions stored on a computer readable medium may be executed to perform one or more of the operations of the method 400. For convenience in describing the method 400, a first, a second, and a third network device may be described. By way of example, these network devices may correspond to network devices 123, 122, and 124 of FIG. 1, respectively.

At block 405, an end user may request content from an ICN network. The content may be any content requested from a network, such as a document, an image, a form, a video, etc. In some embodiments, the request may result in the network routing an interest packet, which requests the content through the network, including through at least the second network device to the first network device and to a content host. At block 410, the content host may begin providing content to the first network device in response to an interest packet.

At block 415, the connection between the content host and the first network device may change. As described above, the change in connection may include the breaking or loss of the connection or the weakening of the signal. The change in connection may be caused by mobility of the content host, mobility of the first network device, or any other event which may cause a weakening of the signal between the content host and the first network device such as a network failure, increase in network load, etc. In some embodiments, the content host may inform the first network device or the first network device may inform the content host about the change in connection. Alternately or additionally, the content host and/or the first network device may notify a location coordinator that the connection has changed. The change of the connection may cause the first network device to cache or otherwise store any pending interest packets directed to the content host that the first network device may receive.

At block 420, the connection between the content host and a third network device may change. The change in connection may include the formation of a connection between the content host and the third network device or may include the strengthening of the connection between the content host and the third network device. At block 425, the pending interest packets stored at the first network device (or the name of the pending interest packets stored at the first network device), as well as the requesting network device (for example, the second network device) may be sent to the location coordinator.

At block 430, the location coordinator may determine a new path to send content packets, responsive to the interest packet, back to the end user. The new path may include at least the third network device and the second network device and be different than the path followed by the initial interest packet between the end user and the content host when the content host was connected to the first network device. By determining a new path, the location coordinator may facilitate intelligent routing of the content packets through the network. As described above, intelligent routing may be based on any number of a variety of factors, including path length (e.g. the shortest path), latency, bandwidth usage, etc. The location coordinator may utilize the maintained status of the topology of the network in determining the new path. For example, the location coordinator may be aware that the second network device is connected to both the first and the third network devices.

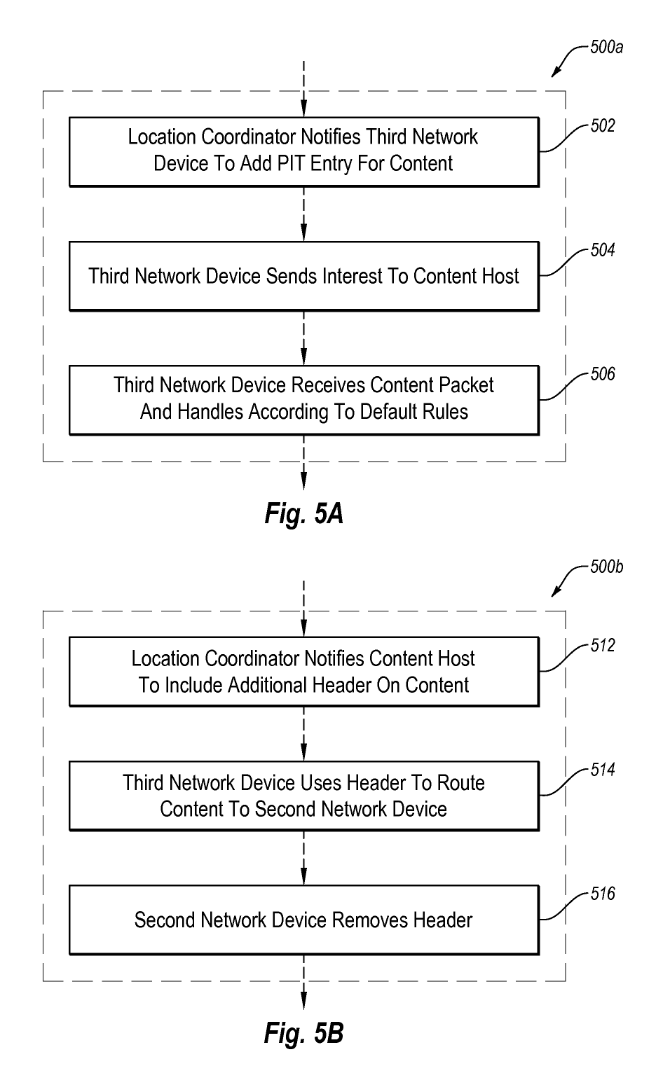

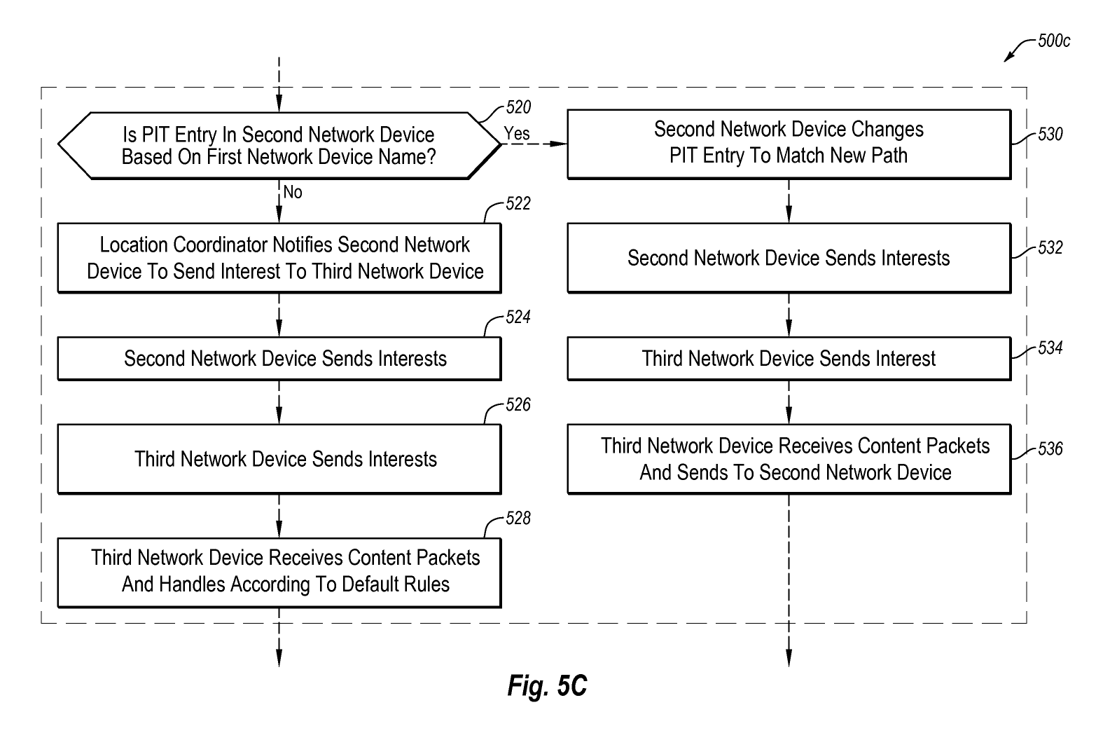

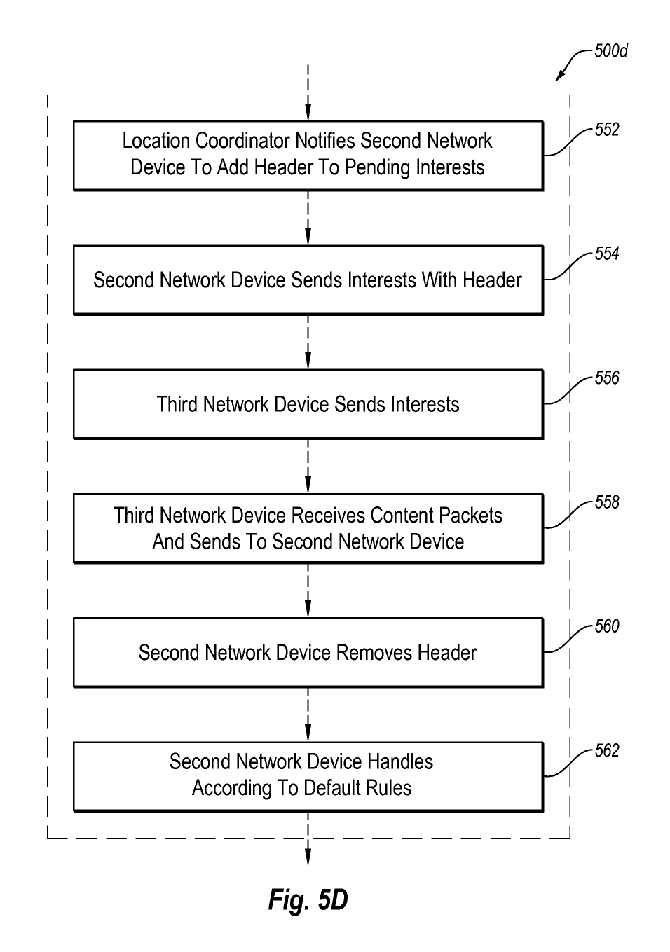

After a new path has been determined, at block 435 the location coordinator may transmit a message with instructions as to how the new path may be implemented. The message and the contents thereof may take a number of different embodiments and may be sent to a number of different elements within the network. Some examples are provided in FIGS. 5A-5D, discussed in greater detail below.

At block 440, a content packet containing the requested content may be routed to the end user through the second network device according to the default rules. As described above, routing the content packet to the end user may include any network devices in the path between the second network device and the end user receiving the content packet, checking the PIT of the network device for an entry for the content in the content packet, if an entry is present, storing the content in the content packet in the content store of the network device, and sending the content packet to the interfaces identified in the PIT entry.

Modifications, additions, or omissions may be made to the method 400 without departing from the scope of the present disclosure. For example, the operations of the method 400 may be implemented in differing order. For example, blocks 415, 420, and 425 may be done in any order. Additionally or alternatively, two or more operations may be performed at the same time. For example, blocks 415, 420, and 425 may be done simultaneously. Furthermore, the outlined operations and actions are only provided as examples, and some of the operations and actions may be optional, combined into fewer operations and actions, or expanded into additional operations and actions without detracting from the essence of the disclosed embodiments. For example, in some embodiments, there may be routing or handling of the content packet before the operation at block 440 that may depart from the default rules.

FIG. 5A is a flowchart of another example method 500a of intelligent routing in an ICN network, according to some embodiments of the present disclosure. The method 500a may be performed by any suitable system, apparatus, or device. For example, the network 100 of FIG. 1 or the computing system 202 of FIG. 2 may perform one or more of the operations associated with the method 500a. As described above, the method 500a may be one example implementation of block 435 of FIG. 4. For example, prior to performing the operations of the method 500a, one or more of the operations at the blocks 405, 410, 415, 420, and 425 of FIG. 4 may be performed. In these and other embodiments, program instructions stored on a computer readable medium may be executed to perform one or more of the operations of the method 500a.

At block 502, the location coordinator may send a notification to the third network device to add a PIT entry for the content with the requesting interface. The requesting interface may be the interface connecting the third network device to the second network device.

At block 504, the third network device may send the interest packet to the content host. At block 506, the content host may provide the content requested in the interest packet to the third network device in a content packet. Because the third network device created a PIT entry for the content based on the message from the location coordinator, the third network device may then process the content packet according to the default rules. Such processing according to the default rules may result in the content packet with the content requested by the end user being routed through the network to the end user.

Modifications, additions, or omissions may be made to the method 500a without departing from the scope of the present disclosure. For example, the operations of the method 500a may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

For example, in some embodiments, the location coordinator may instruct the first network device to cache or otherwise store any pending interest packets that are received during the change in connection between the content host and the first network device and/or the change in connection between the content host and the third network device. In some embodiments, after the location coordinator has received notification from the third network device that the connection between the content host and the third network device content host is routing content packets, the location coordinator may request the first network device to send the pending interest packets for the content host received at the first network device. The timing of the location coordinator requesting the pending interest packets from the first network device may be based on the messaging protocols used in forming and inquiring regarding the status of the connections, on the routing protocol used in the network, etc.

FIG. 5B is a flowchart of a further example method 500b of intelligent routing in an ICN network, according to some embodiments of the present disclosure. The method 500b may be performed by any suitable system, apparatus, or device. For example, the network 100 of FIG. 1 or the computing system 202 of FIG. 2 may perform one or more of the operations associated with the method 500a. As described above, the method 500b may be one example implementation of block 435 of FIG. 4. For example, prior to performing the operations of the method 500b, one or more of the operations at the blocks 405, 410, 415, 420, and 425 of FIG. 4 may be performed. In these and other embodiments, program instructions stored on a computer readable medium may be executed to perform one or more of the operations of the method 500b.

At block 512, the location coordinator may notify the content host in a message to include an additional header on top of the content packet. The message may be sent directly to the content host or may be sent to the third network device to be relayed to the content host. The additional header may include a target network device, or may include a series of network devices along the new path determined by the location coordinator. At block 514, the third network device may receive the content packet with the additional header. The third network device may route the content packet according to the additional header. For convenience in describing the method 500b, the target network device may be the second network device. At block 516, when the content packet with the additional header is received at the target network device or the final network device named in the additional header (the second network device), the target or final network device may remove the additional header. The content packet may then be routed through the network to the end user, for example, using the default rules.

Modifications, additions, or omissions may be made to the method 500b without departing from the scope of the present disclosure. For example, the operations of the method 500b may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

FIG. 5C is a flowchart of an additional example method 500c of intelligent routing in an ICN network, according to some embodiments of the present disclosure. The method 500c may be performed by any suitable system, apparatus, or device. For example, the network 100 of FIG. 1 or the computing system 202 may perform one or more of the operations associated with the method 500c. As described above, the method 500c may be one example implementation of block 435 of FIG. 4. For example, prior to performing the operations of the method 500c, one or more of the operations at the blocks 405, 410, 415, 420, and 425 of FIG. 4 may be performed. In these and other embodiments, program instructions stored on a computer readable medium may be executed to perform one or more of the operations of the method 500c.

At block 520, the location coordinator may determine whether the pending interest packet entries in the PIT at the second network device include the name of the first network device in the entry for the interest packet. For example, depending on the routing protocol used in the FIB or other factors, the interest packet may include the first network device's name in the PIT entry. For example, if not dependent on the name of the first network device the entry may include/Fujitsu.com/global/about/businesspolicy/tech/index.html/v3/s2. If the entry is dependent on the name of the first network device it may include first_device/Fujitsu.com/global/about/businesspolicy/tech/index.html/v3/s2. If the PIT entry is not based on the first network device's name, or in other words, if the interest packet does not include the name of the first network device, the method 500c may proceed to block 522. At block 522, the location coordinator may notify the second network device to send an interest packet to the third network device requesting the content. Such notification may include informing the second network device to forward the pending interest packets to the third network device. The notification from the location coordinator may also cause or instruct the second network device to create an updated PIT entry requesting the content from the third network device. Updating the PIT entry may occur according to the default rules as the second network device sends out the interest packet to the third network device. At block 524, the second network device may send the interest packet to the third network device. In some embodiments, the name of the third network device may be carried in the interest packet as a forwarding hint such that the interest packet may be forwarded to the third network device. At block 526, the third network device may receive the interest packet from the second network device and handle the interest packet according to the default rules, which may result in the third network device sending the interest packet to the content host. At block 528, the content host may send the content in a content packet to the third network device in response to the interest packet. The content packet may then be handled according to the default rules and be routed back to the end user through the network.

At block 520, if it is determined that the PIT entry is based on the name of the first network device, the method 500c may proceed to block 530. At block 530, the location coordinator may send a notification to the second network device to modify the PIT entry to change the dependence from the first network device to the third network device. For example, if the name were /first_device/Fujitsu.com/global/about/businesspolicy/tech/index.html/v3/s2, the entry may be changed to /third_device/Fujitsu.com/global/about/businesspolicy/tech/index.html/v3/s2. The name of the interest packet may also be updated accordingly with the new name /third_device/Fujitsu.com/global/about/businesspolicy/tech/index.html/v3/s2. At block 532, the second network device may then send the updated interest packet to the third network device based on the FIB, which may be routed to the third network device because of the change in the name. At block 534, the third network device may receive the interest packet and may send the interest packet to the contest host according to the default rules. At block 536, the content host may receive the interest packet and send the requested content in a content packet to the third network device in response to the interest packet, and the third network device may handle the content packet according to the default rules, including sending the content packet to the second network device, which may result in the content packet being routed to the end user.

Modifications, additions, or omissions may be made to the method 500c without departing from the scope of the present disclosure. For example, the operations of the method 500c may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

FIG. 5D is also a flowchart of an example method 500d of intelligent routing in an ICN network, according to some embodiments of the present disclosure. The method 500d may be performed by any suitable system, apparatus, or device. For example, the network 100 of FIG. 1 or the computing system 202 of FIG. 2 may perform one or more of the operations associated with the method 500d. The method 500d may be an alternative embodiment in which the location coordinator may communicate with the second network device and the PIT entry in the second network device is based on the name of the first network device. Stated another way, blocks 552 through 562 may replace blocks 530 through 536 in FIG. 5C. For example, prior to performing the operations of the method 500d, one or more of the operations at the blocks 405, 410, 415, 420, and 425 of FIG. 4 and the operation at the block 520 of FIG. 5C may be performed.

At block 552, the location coordinator may notify the second network device to include an additional header in the pending interest packets originally routed to the first network device. The additional header may be used to identify the third network device as the location to which the pending interest packets may now be routed. At block 554, the second network device may send the pending interest packets with the additional header identifying the third network device to the third network device. At block 556, the third network device may send the interest packet to the content host. The third network device may retain the additional header in the interest packet. The content host may receive the interest packet and send the content packet back to the third network device.

In some embodiments, the content host may be instructed to take the additional header from the interest packet and include it on top of the content packet. At block 558, the third network device may receive the content packet with the additional header and send it to the second network device. The content packet may be handled according to the default rules by the third network device. At block 560, the second network device may remove the additional header from the content packet that identified the path through the third network device. At block 562, the second network device may handle the content packet according to the default rules. Handling the content packet according to the default rules may result in the content packet being routed through the network to the end user.

Modifications, additions, or omissions may be made to the method 500d without departing from the scope of the present disclosure. For example, the operations of the method 500d may be implemented in differing order. Additionally or alternatively, two or more operations may be performed at the same time. Furthermore, the outlined operations and actions are only provided as examples, and some of the operations and actions may be optional, combined into fewer operations and actions, or expanded into additional operations and actions without detracting from the essence of the disclosed embodiments.

As described above, in some embodiments the location coordinator may instruct the first network device to cache or otherwise store any pending interest packets that are received during the change in connections between the content host and the first network device. In some embodiments, after the location coordinator has received notification from the third network device that the connection between the content host and the third network device content host is routing content packets, the location coordinator may request the first network device to send the pending interest packets for the content host that are received at the first network device. The timing of the location coordinator requesting the pending interest packets from the first network device may be based on the messaging protocols used in forming and inquiring regarding the status of the connections, on the routing protocol used in the network, etc. The location coordinator may then proceed to communicate with the second network device as described in the present disclosure, including in FIGS. 5C and 5D.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method of intelligent routing in an information centric networking (ICN) network, the method comprising:
receiving a first notification that a connection between a content host and a first network device has changed;
receiving a pending interest packet from the first network device, the pending interest packet requesting content stored on the content host, the content to be routed to a second network device;
receiving a second notification that a connection between the content host and a third network device has changed;
determining a new path to the second network device for the content requested by the pending interest packet that includes the third network device; and
sending a message to instruct that a content packet containing the content responsive to the pending interest packet be routed to the second network device along the new path.

2. The method of claim 1, wherein sending the message includes sending the message to the third network device.

3. The method of claim 2, wherein the message instructs the third network device to add a pending interest table (PIT) entry for the pending interest packet, and instructs the third network device to send a corresponding interest packet to the content host.

4. The method of claim 2, wherein the message instructs the third network device to request that the content host add an additional header for content packets responsive to the pending interest packet, the additional header identifying the second network device as a target network device.

5. The method of claim 1, wherein sending the message includes sending the message to the second network device.

6. The method of claim 5, further comprising:
determining whether an interest packet pending at the second network device includes a name of the first network device; and
upon a determination that the interest packet pending at the second network device does not include the name of the first network device, constructing the message to instruct the second network device to send the interest packet pending at the second network device to the third network device.

7. The method of claim 5, further comprising:
determining whether an interest packet pending at the second network device includes a name of the first network device; and
upon a determination that the interest packet pending at the second network device includes the name of the first network device, constructing the message to instruct the second network device to modify a PIT entry associated with the interest packet pending at the second network device to include the name of the third network device instead of the first network device and to instruct the second network device to send the interest packet pending at the second network device to the third network device.

8. The method of claim 5, further comprising:
determining whether an interest packet pending at the second network device includes a name of the first network device; and
upon a determination that the interest packet pending at the second network device includes the name of the first network device, constructing the message to instruct the second network device to include an additional header in the interest packet pending at the second network device to identify the third network device as a target network device for the interest packet pending at the second network device.

9. The method of claim 1, wherein sending the message includes sending the message to the content host.

10. The method of claim 9, wherein the message requests that the content host add an additional header for content packets responsive to the pending interest packet, wherein the additional header identifies the second network device.

11. The method of claim 1, further comprising sending a notification to the first network device to cache any incoming interest packets requesting content from the content host until the connection between the content host and the third network device is selected to handle the pending interest packets.

12. A non-transitory computer-readable medium containing instructions that, when executed by a processor, are configured to perform operations, the operations comprising:
receiving a first notification that a connection between a content host and a first network device has changed;
receiving a pending interest packet from the first network device, the pending interest packet requesting content stored on the content host, the content to be routed to a second network device;
receiving a second notification that a connection between the content host and a third network device has changed;
determining a new path to the second network device for the content requested by the pending interest packet that includes the third network device; and
sending a message to instruct that a content packet containing the content responsive to the pending interest packet be routed to the second network device along the new path.

13. The computer-readable medium of claim 12, wherein sending the message includes sending the message to the third network device.

14. The computer-readable medium of claim 13, wherein the message instructs the third network device to add a pending interest table (PIT) entry for the pending interest packet, and instructs the third network device to send a corresponding interest packet to the content host.

15. The computer-readable medium of claim 13, wherein the message instructs the third network device to request that the content host add an additional header for content packets responsive to the pending interest packet, the additional header identifying the second network device as a target network device.

16. The computer-readable medium of claim 12, wherein sending the message includes sending the message to the second network device.

17. The computer-readable medium of claim 16, wherein the operations further comprise:
determining whether an interest packet pending at the second network device includes a name of the first network device; and
upon a determination that the interest packet pending at the second network device does not include the name of the first network device, constructing the message to instruct the second network device to send the interest packet pending at the second network device to the third network device.

18. The computer-readable medium of claim 16, further comprising:
determining whether an interest packet pending at the second network device includes a name of the first network device; and
upon a determination that the interest packet pending at the second network device includes the name of the first network device, constructing the message to instruct the second network device to modify a PIT entry associated with the interest packet pending at the second network device to include the name of the third network device instead of the first network device and to instruct the second network device to send the interest packet pending at the second network device to the third network device.

19. The computer-readable medium of claim 16, further comprising:
determining whether an interest packet pending at the second network device includes a name of the first network device; and
upon a determination that the interest packet pending at the second network device includes the name of the first network device, constructing the message to instruct the second network device to include an additional header in the interest packet pending at the second network device to identify the third network device.

20. The computer-readable medium of claim 17, wherein sending the message includes sending the message to the content host, the message requesting that the content host add an additional header for a content packet responsive to the pending interest packet, wherein the additional header identifies the second network device.
